(19) United States
(12) Patent Application Publication
(10) Pub. No.: US 2019/0347512 A1
(43) Pub. Date: Nov. 14, 2019

(54) EMPLOYING VEHICULAR SENSOR INFORMATION FOR RETRIEVAL OF DATA

(71) Applicant: VISTEON GLOBAL TECHNOLOGIES, INC., Van Buren Township, MI (US)

(72) Inventors: Upton Beall BOWDEN, Van Buren Township, MI (US); Vijay Jayant NADKAMI, San Jose, CA (US)

(21) Appl. No.: 16/474,311

(22) PCT Filed: Jan. 2, 2018
(86) PCT No.: PCT/US2018/012053

§ 371 Date: Jun. 27, 2019

Related U.S. Application Data
(60) Provisional application No. 62/441,541, filed on Jan. 2, 2017.

(51) Int. Cl. G06K 9/62; G08G 1/16

(52) U.S. Cl. CPC G06K 9/623; G06K 9/00369; G06K 9/627; G08G 1/166

(57) ABSTRACT

The aspects disclosed herein are directed to improvements to an object detection system incorporated in a vehicle-based context, and particularly for autonomous vehicle implementations. When performing autonomous vehicle control, identifying objects as stationary/mobile (i.e., pedestrians, other vehicles, or objects), is imperative. As such, designing methods to streamline said operations to avoid a wholesale search of database can greatly improve a vehicle's performance especially in an autonomous vehicle driving context.

### CROSS REFERENCE TO RELATED APPLICATION

This PCT International Patent Application claims the benefit of U.S. Provisional Patent Application Ser. No. 62/441,541 filed on Jan. 2, 2017, the entire disclosure of this application being considered part of the disclosure of this application, and hereby incorporated by reference.

### BACKGROUND

Vehicles, such as automobiles, motorcycles and the like, are being provided with image or video capturing devices to capture surrounding environments. These devices are being provided so as to allow for enhanced driving experiences. With surrounding environments being captured, through processing, the surrounding environment can be identified, or objects in the surrounding environment may also be identified.

For example, a vehicle implementing an image capturing device configured to capture a surrounding environment may detect road signs indicating danger or information, highlight local attractions and other objects for education and entertainment, and provide a whole host of other services.

This technology becomes even more important as autonomous vehicles are introduced. An autonomous vehicle employs many sensors to determine an optimal driving route and technique. One such sensor is the capturing of real-time images of the surrounding, and processing driving decisions based on said captured image.

Existing techniques involve increasing the processing power of devices situated in vehicles. Thus, the conventional technique for performing this indexing or retrieval of information based on a captured image is shown and illustrated in FIG. 1 (via progression 100).

Data is captured (via an image) and searched through the whole collection of data associated with stored images. Thus, when a vehicle's front facing camera captures an image, this image is then searched against all data stored in a storage device (for example, a cloud-connected storage device). This ultimately leads to an identification of the data item shown in FIG. 1, with the right most level of data in progression 100.

Thus, because the process of searching every data item becomes potentially processor heavy, vehicle implementers are attempting to incorporate processors with greater capabilities and processor power.

### SUMMARY

The following description relates to system and methods for employing vehicle sensor information for the retrieval of data. Further aspects may be directed to employing said systems and methods for an autonomous vehicle processor for the identification of objects (either stationary or moving).

Additional features of the invention will be set forth in the description which follows, and in part will be apparent from the description, or may be learned by practice of the invention.

The aspects disclosed herein are directed to a method for identifying objects in a vehicular-context. The method includes capturing an object via an image/video capturing device installed with a vehicle; removing non-relevant data based on at least one identified aspect of said object; determining whether the object is a vehicle or pedestrian after removing non-relevant data; and communicating the determination to a processor.

The aspects disclosed herein are directed to said method also including an autonomous vehicle.

The aspects disclosed herein are directed to said method is also defined where the removing and determining further includes maintaining a neural network data set of all objects associated with drive-able conditions; sorting each sets of data based on a plurality of characteristics; and in performing the determining, skipping neural network data sets based on the identified aspect not overlapping with at least one of the plurality of characteristics.

The aspects disclosed herein are directed to said method where the identified aspect is defined as a time of day.

The aspects disclosed herein are directed to said method where the identified aspect is defined as a date.

The aspects disclosed herein are directed to said method where the identified aspect is defined as a season.

The aspects disclosed herein are directed to said method where the identified aspect is defined on an amount of light.

The aspects disclosed herein are directed to said method where the identified aspect is defined on weather conditions.

The aspects disclosed herein are directed to said method where the identified aspect is defined on information received from a global positioning satellite.

The aspects disclosed herein are directed to said method where the identified aspect is defined on detected weather.

The aspects disclosed herein are directed to said method where the identified aspect is defined whether there is snow or rain present.

The aspects disclosed herein are directed to said method where the identified aspect is defined whether the identified aspect is based on a detected environment.

The aspects disclosed herein are directed to said method where the identified aspect is defined on detected fauna.

The aspects disclosed herein are directed to said method where the identified aspect is defined on a unique identifier associated with a specific region.

The aspects disclosed herein are directed to said method where the identified aspect is defined on a unique sign associated with a specific region.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of a neural network implementation.

FIG. 2 illustrates a high-level explanation of the aspects disclosed herein.

FIG. 3 illustrates a method for limiting data based on capturing data.

FIGS. 4(a), 4(b) and 4(c) illustrate an example of method shown in FIG. 3.

FIG. 5 illustrates an example table of parameters employable with the method shown in FIG. 3.

FIG. 6 illustrates a method for object identification employing the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained above, vehicle implementers are implementing processors with increased capabilities, thereby attempting perform the search for captured data via a complete database in an optimal manner. However, these techniques are limited in that they require increased processor resources, costs, and power to accomplish the increased processing.

Disclosed herein are devices, systems, and methods for employing vehicular sensor information for retrieval of data. By employing the aspects disclosed herein, the need to incorporate more powerful processing power is obviated. As such, the ability to identify images, or objects in the images, is accomplished in a quicker fashion, with the gains being achieved of a cheaper, less resource intensive, and low power implementation of a vehicle-based processor.

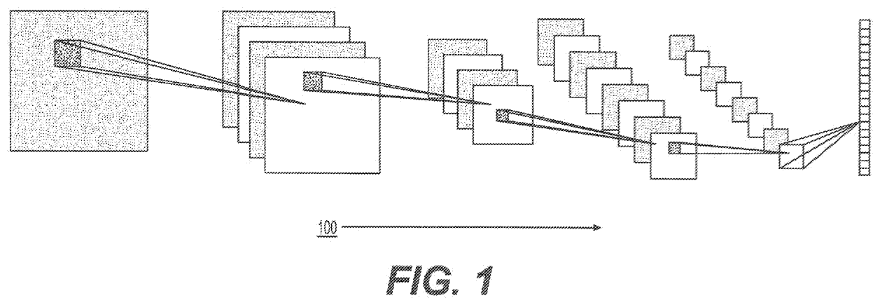

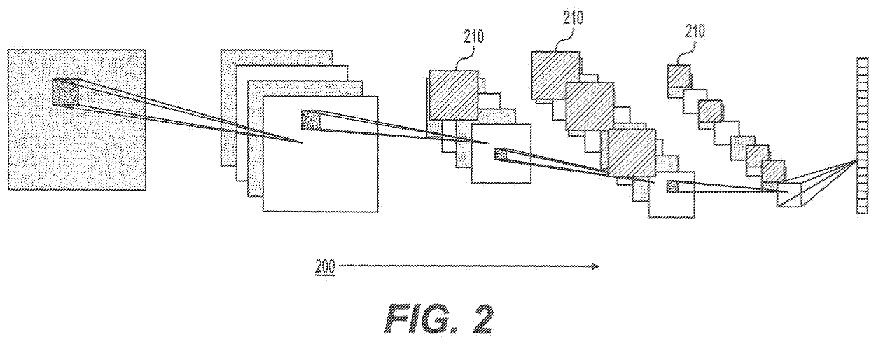

FIG. 2 illustrates a high-level explanation of the aspects disclosed herein. Similar to FIG. 1, a single image is compared against a complete set of images, which is narrowed down from left to right, as shown by progression 200. However, in addition to narrowing down, additional information sourced from a vehicle sensor is provided, thereby allowing the narrowing to occur with additional information (which is shown by data item 210 being removed from an analysis). The vehicle sensor information provided will be described in greater detail below, as various embodiments of the disclosure are described in greater detail.

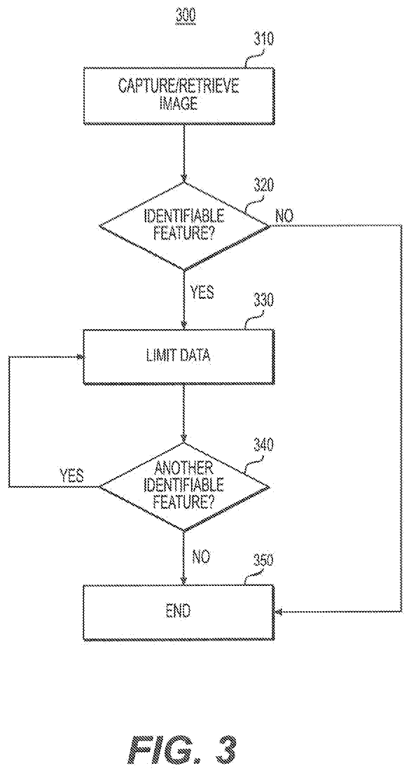

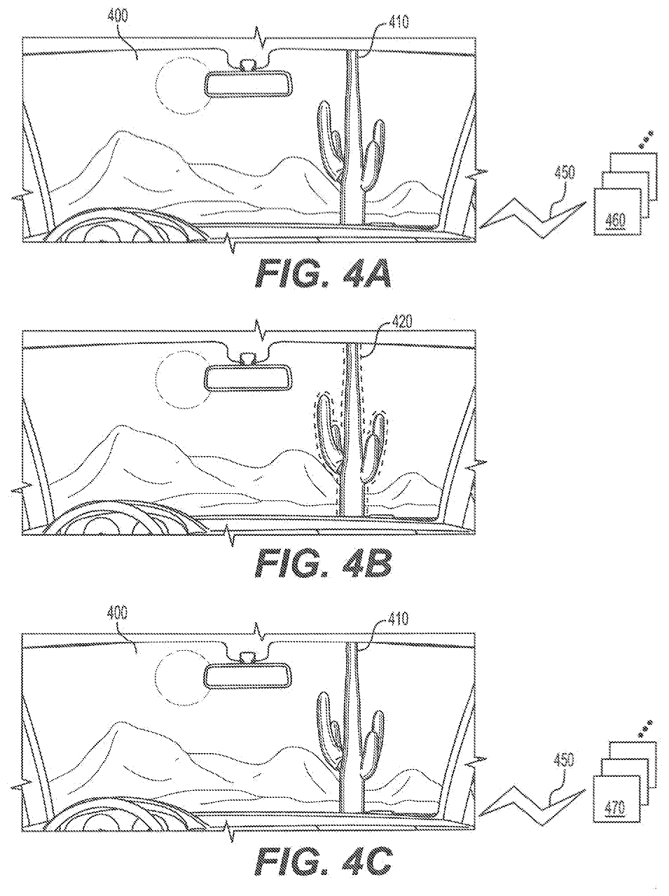

FIGS. 3, 4(a), 4(b) and 4(c) illustrate a method 300 and example associated with an embodiment disclosed herein. The method 300 may be configured to be installed or programmed into a vehicular microprocessor, such as a centrally situated electronic control unit (ECU), or via a network connected processor in which the vehicle 400 communicates with, and sends and receives data to/from.

Specifically, in operation 310, an image surrounding the vehicle is capture. In FIG. 4(a), this is exemplified via the vehicle 400's outward facing direction (through the windshield view). In the image captured, there is a cactus 410, and as such, the vehicle 400's operator or some application installed therein may require or request an identification of the cactus (to denote a landmark or to provide information about that cactus or all cacti) or retrieve a similar image based on the present captured location shown. The cactus 410 is merely an exemplary object. Other objects may be employed, such as other vehicles, pedestrians, and the like. The data captured in operation 310 is communicated to a network 450 to search through a complete database 460 to determine a stored image or data correlating with the captured view.

In operation 320, a determination is made as to whether there are any identifiable objects in the captured image. If no, the method 300 proceeds to end 350. If yes, the method 300 proceeds to operation 330.

In operation 330, an item or test is employed to limit the data being searched through. For example, the system may identify a cactus (as shown in FIG. 4(b) with highlight 420 around said cactus). Thus, the database of images may be limited to only images associated with regions where cactus grow and/or are found.

The limiting of data may be performed iteratively with other criteria to limit data. The following is a list of methods to limit data in accordance with the aspects disclosed herein (or various combinations thereof):
1) Time.
2) Date/Season (for example knowing what time of year it is, the data may be limited to images associated with lightness or darkness based on the present date).
3) Day.
4) Sunrise/Sunset/Night.
5) GPS location (hemisphere, country, state).
6) Weather (for example, the capturing of snow would indicate to exclude certain areas altogether).
7) Driving conditions (rain, snow, sun).
8) Environment (dessert, forest, etc.).
9) Local flora/fauna (see example in FIG. 4(b)).
10) Unique objects to a specific area.
11) Types of signs or information obtained from signs.

In FIG. 4(c), once the data is limited, data from data set 470 may be searched for. Data set 470 may be considerably smaller than data set 460 (due to the limitation performed in operation 330), and as such, the searched-through data set 470 may occur at a faster rate with less resources and power consumed.

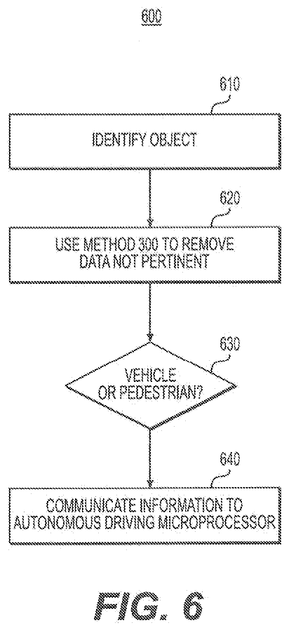

FIG. 6 illustrates a method 600 for a second embodiment of the aspects disclosed herein. As noted above, the need of identifying objects in captured images becomes paramount in operating vehicles for advanced sensor applications, and especially autonomous vehicle operation. Specifically, the ability to identify objects is needed for two purposes, identifying an object as moving (vehicle, pedestrian) or static.

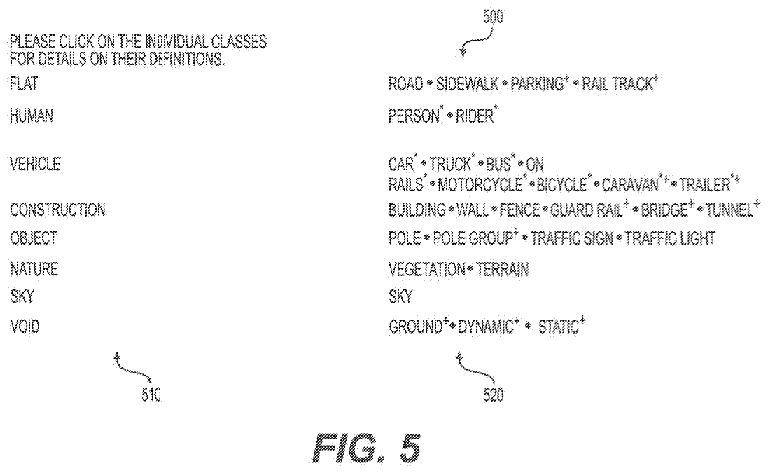

FIG. 5 illustrates a list of objects via a table 500 that are needed to be identified for autonomous vehicle operation. Field 510 illustrates a category, and field 520 illustrates the various sub-categories associated with each category.

In operation 610, an object is highlighted as needed to be identified is determined. For example, in the field of autonomous vehicles, a moving object ahead may be identified as to be determined.

In operation 620, the method 400 is used to limit the whole database of available images/objects to be searched for. As such, the identified object may be compared against a smaller subset.

In operation 630, the object may be identified (for example, as a vehicle, pedestrian, or any of the objects listed in FIG. 5). After which, the identified object may be communicated to a central processor to employ in an application, such as autonomous driving or the like.

As a person skilled in the art will readily appreciate, the above description is meant as an illustration of implementation of the principles this invention. This description is not intended to limit the scope or application of this invention in that the invention is susceptible to modification, variation, and change, without departing from spirit of this invention, as defined in the following claims.

What is claimed is:

1. A method for identifying objects in a vehicular-context comprising:
capturing an object via an image/video capturing device installed with a vehicle;
removing non-relevant data based on at least one identified aspect of said object;
determining whether the object is a vehicle or pedestrian after removing nonrelevant non-relevant data; and
communicating the determination to a processor.

2. The method according to claim 1, wherein the processor is installed in an autonomous vehicle.

3. The method according to claim 2, wherein the removing and determining further comprises:
maintaining a neural network data set of all objects associated with drive-able conditions;
sorting each sets of data based on a plurality of characteristics; and
in performing the determining, skipping neural network data sets based on the identified aspect not overlapping with at least one of the plurality of characteristics.

4. The method according to claim 3, wherein the identified aspect is defined as a time of day.

5. The method according to claim 3, wherein the identified aspect is defined as a date.

6. The method according to claim 3, wherein the identified aspect is defined as a season.

7. The method according to claim 3, wherein the identified aspect is defined based on an amount of light.

8. The method according to claim 3, wherein the identified aspect is defined based on weather conditions.

9. The method according to claim 3, wherein the identified aspect is defined on information received from a global positioning satellite.

10. The method according to claim 3, wherein the identified aspects is defined on detected weather.

11. The method according to claim 10, wherein the identified aspect is further defined on whether there is snow or rain present.

12. The method according to claim 3, wherein the identified aspect is defined on a detected environment.

13. The method according to claim 3, wherein the identified aspect is defined on detected fauna.

14. The method according to claim 3, wherein the identified aspect is defined on a unique identifier associated with a specific region.

15. The method according to claim 3, wherein the identified aspect is defined on a unique sign associated with a specific region.

16. A system for a vehicle, the system comprising:
an image capturing device of the vehicle and configured to capture an object;
a network processor configured to:
receive the captured object;
search a database of objects to determine whether the captured object includes at least one identifiable object;
remove non-relevant data based on a determination that the captured object includes at least one identifiable object; and
determine whether the object is a vehicle or pedestrian after removing non-relevant data; and
a vehicle processor configured to receive the determination of whether the object is a vehicle or pedestrian after removing non-relevant data.

17. The system of claim 16, wherein the vehicle includes an autonomous vehicle.

18. The system of claim 16, wherein the image capturing device is disposed on a front portion of the vehicle.

19. An apparatus for a vehicle, comprising:
a microprocessor disposed within the vehicle and configured to:
receive a captured object;
maintain a neural network data set of all objects associated with drive-able conditions;
sort each data set based on a plurality of characteristics
search a data sets to determine whether the captured object includes at least one identifiable object;
remove non-relevant data based on a determination that the captured object includes at least one identifiable object; and
skip data sets based on a determination that the identifiable object does not overlap with at least one of the plurality of characteristics;
determine whether the object is a vehicle or pedestrian after removing non-relevant data; and
communicate the determination of whether the object is a vehicle or pedestrian after removing non-relevant data.

20. The apparatus of claim 19, wherein the vehicle includes an autonomous vehicle.
